(19) United States
(12) Patent Application Publication
(10) Pub. No.: US 2012/0042269 A1
(43) Pub. Date: Feb. 16, 2012

(54) SYSTEM AND METHOD FOR NESTING TIMELINES

(75) Inventor: James Holman, Tacoma, WA (US)

(73) Assignee: Holman Enterprises, LLC, Tacoma, WA (US)

(21) Appl. No.: 13/048,825

(22) Filed: Mar. 15, 2011

Related U.S. Application Data
(60) Provisional application No. 61/314,047, filed on Mar. 15, 2010.

(51) Int. Cl. G06F 3/048

(52) U.S. Cl. 715/764

(57) ABSTRACT

A system and method for creating, editing, and displaying nested timelines. Using the disclosed system, a user can create linked timelines within a timeline and represent the linked (or “nested”) timelines as single elements in the timeline. Nested timelines allow a user to remove elements from a timeline to avoid cluttering the timeline or to group certain events together. Nested timelines also allow a user to alter the timescale for displaying events. The system allows the viewer to easily switch between the parent timeline and the nested timeline as necessary to view the events associated with each timeline. In some embodiments, the system allows various graphical elements representing a span of time, events, nested timelines, and annotations to be added to a timeline.

### CROSS-REFERENCE TO RELATED APPLICATION(S)

This application claims the benefit of U.S. Provisional Application No. 61/314,047, filed Mar. 15, 2010, entitled “SYSTEM AND METHOD FOR NESTING TIMELINES,” which is incorporated herein by reference in its entirety.

### BACKGROUND

When making presentations to large groups, users are limited in the tools that they can use to create presentations. Any tool used for this purpose must be capable of displaying information in an attractive and clear format that can be easily understood by an audience. For presentations involving a large amount of data, this task can present significant challenges. One such challenge is overcoming information overload by the viewer, a phenomenon that may cause a viewer to stop absorbing critical information that is presented in a cluttered or visually unappealing way. This problem can be particularly severe when the information being conveyed relates to a series of events linked by a temporal relationship.

Several tactics are commonly employed in an attempt to overcome this problem. Among them are displaying information in large type, color coding information so that different categories of information may be more discernable and more easily absorbed by the user, or by presenting information in a bullet point format that enables users to more readily appreciate the hierarchical relationships among the informational items being conveyed. While these tactics can be very helpful to convey large amounts of information, they are unable to present information in a way that is visually streamlined and uncluttered, and therefore more likely to be absorbed usefully by the viewer. Moreover, these known tactics do not allow a presenter to easily condense a subset of the available information into a detailed subset that optionally may be displayed during a presentation, depending on the level of detail desired by the presenter or by the audience.

### BRIEF DESCRIPTION OF THE DRAWINGS

FIG. 1 is a block diagram of a system to create, modify, and display nested timelines.

FIG. 2 is a display of a representative timeline generated by the system.

FIG. 3 is a display of a representative nested timeline generated by the system.

FIG. 4 is a flow diagram illustrating the process by which a timeline is created by the system.

FIG. 5 is a display of a timeline hierarchy menu generated by the system.

### DETAILED DESCRIPTION

A system and method for creating, editing, and displaying nested timelines is provided. A timeline provides a visual representation of a series of events, allowing a viewer to better appreciate or comprehend the temporal relationships between events. A timeline could be useful, for example, in a presentation to a classroom, a business strategy meeting, a civic planning session, a construction overview, a jury, or to any other audience where a structured display of events would allow the audience to better visualize the chronology of events. A timeline may be created, for example, to show the relationship of the planning process, permitting requirements, architectural or design decisions, and construction milestones that must be achieved for the development of a commercial office building. A timeline may also be created, for example, to display the events associated with a personal injury action (e.g., the injury, doctor visits, physical therapy sessions, negotiations with insurance companies, and the filing of a complaint).

Using the disclosed system, a user can create linked timelines within a timeline and represent the linked (or “nested”) timelines as single elements in the timeline. A nested timeline may be accessed and displayed as a separate timeline, herein referred to as a “nested timeline.” The timeline to which a nested timeline is linked is referred to as a “parent timeline.” A timeline that does not have a parent timeline is referred to as a “primary timeline.” Nested timelines allow a user to remove elements from a timeline to avoid cluttering the timeline or to group certain events together. Nested timelines also allow a user to alter the timescale for displaying events. A parent timeline may have one timescale, and a nested timeline may have a different timescale. For example, a timeline spanning two decades may have a timescale of one year per inch. If a significant number of events were to be presented on a single day on the parent timeline, it would be difficult to represent each event with enough detail for a viewer to interpret the events or the relationships between the events. A nested timeline may therefore be created by the user, the nested timeline having a scale of one inch corresponding to a week, a day, an hour, a second, etc. The system allows the viewer to easily switch between the parent timeline and the nested timeline as necessary to view the events associated with each timeline. Nested timelines allow a user to display a shorter period, and the events associated with that period, in a clearer fashion than if the events were incorporated on the primary timeline.

In some embodiments, the system allows various graphical elements representing a span of time, events, nested timelines, and annotations to be added to a timeline. A timescale representing the span of time associated with a particular timeline may consist of a horizontal line with a start time and an end time displayed in the timeline. Elements representing events are connected to the timescale at a point corresponding to the time at which the event occurred. Annotations allow a user to add information to a timeline that is not associated with a particular event or time. For example, an annotation might include text describing the timeline, such as “Personal Injury Timeline,” or might include an image of an injured party.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

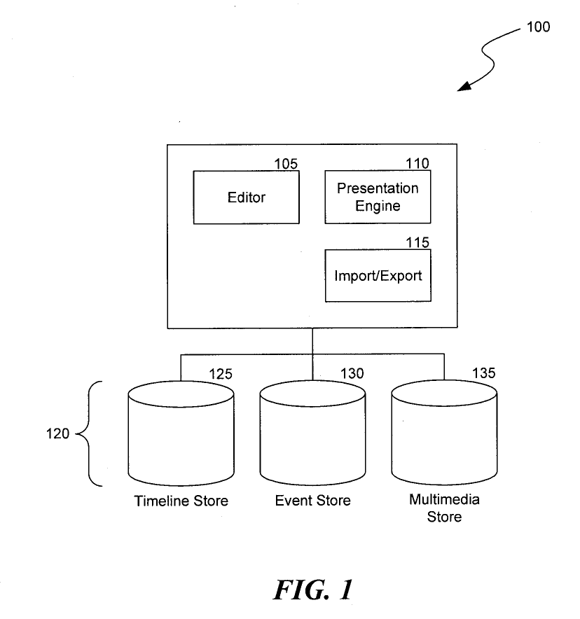

FIG. 1 is a block diagram of a system 100 that allows a user to create, modify, and display nested timelines. A timeline is a graph of a time period upon which two or more events are graphically presented in a manner that shows the relationship of events with respect to a particular time scale. Nested timelines are timelines that overlap over a period of time, wherein a parent or primary timeline graphically illustrates the occurrence of events with one time scale and children or secondary timelines graphically illustrate the occurrence of events with different time scales. A timeline is nested in the sense that two or more timelines are linked so that a user viewing one timeline may easily expand a portion of that timeline to view a related timeline. The system allows a user to create, store, modify, and view events on the nested timelines. The system includes an editor 105 that allows a user to create, manipulate and store timelines and a presentation engine 110 that interprets and displays stored timelines. The system may also include an import/export component 115 that allows stored timelines to be exported to other applications or service. The system is coupled to one or more data stores 120 that contain the data for the construction and display of a timeline. The data stores may include a timeline store 125 that stores timeline information data structures, an event store 130 that stores event information data structures, and a multimedia store 135 that stores multimedia files (i.e., files containing one or more of audio, video, text, images). Multimedia files may be associated with timelines, nested timelines, or timeline events. When a multimedia file is associated with a timeline or timeline event, the multimedia file may be embedded into a timeline information data structure or an event information data structure. The data stores may be located proximate to the system or one of the data stores may be located remote from the system and accessed via a public or private network. Further details about the construction and presentation of timelines may be found in the concurrently-filed U.S. patent application entitled “SYSTEM AND METHOD FOR CREATING AND DISPLAYING A TIMELINE PRESENTATION,” attorney docket number 58758-8002.US03, which is incorporated herein by reference in its entirety.

The system 100 may be implemented in a computing device having a central processing unit, memory, input devices (e.g., keyboard and pointing devices), output devices (e.g., display devices), and storage devices (e.g., disk drives). The memory and storage devices are non-transitory computer-readable media that may be encoded with computer-executable instructions that implement the timeline system. Embodiments of the system may be implemented in and used with various operating environments that include personal computers, server computers, hand-held or laptop devices, multiprocessor systems, microprocessor-based systems, programmable consumer electronics, network PCs, computing environments that include any of the above systems or devices, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

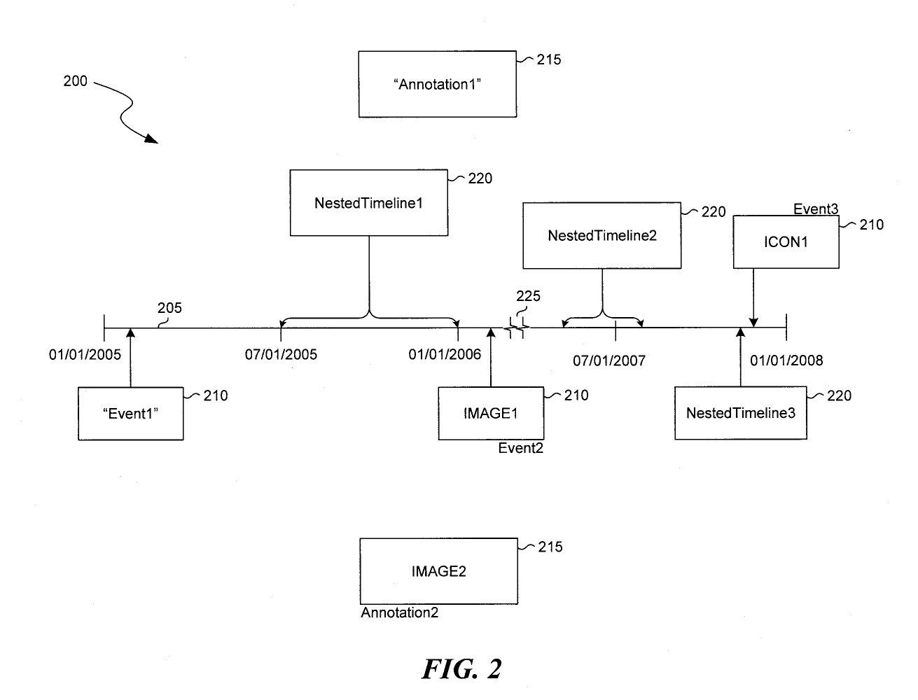

FIG. 2 is a display of a representative timeline 200 generated by the system. The timeline consists of a timescale 205, events 210, annotations 215, nested timeline identifiers 220, and break elements 225. The timescale 205 is a graphical representation of a collection of time or dates. For example, in FIG. 2 the timescale is represented as a horizontal line across the page with five dates displayed along the line (e.g., “Jul. 1, 2005”). The timescale may be represented as a vertical bar, curved line, or any other graphical representation linking times or dates. The timescale typically includes date and time information so that a viewer of the timeline is able to understand the relative progression of events. The system operator may specify which points in time are displayed in the timeline or the number of points in time that are displayed in the timeline.

The system allows users to add one or more events 210 to the timescale. In FIG. 2, three events have been added to the timescale: Event1, Event2, and Event3. The events may be visually represented in a variety of different treatments. For example, the representation of Event1 includes a text box, the representation of Event2 includes an image (“IMAGE1”), and the representation of Event3 includes an icon (“ICON1”). Each of the events is connected by an arrow to the timeline at a point in time when the event occurred. The system allows events to be easily added and removed from the timeline.

Each event 210 on the timeline may have a multimedia file that is associated with the event. A multimedia file may include audio or visual content, such as a sound clip, a slideshow, a video clip, etc. A multimedia file may also contain a document or documents that are associated with an event, such as a copy of a lease, a scan of a signed letter that was sent to another party, a spreadsheet containing accounting information for a business, a birth certificate, etc. In some embodiments, the system may provide an icon or other indication on the event indicating that there is a multimedia file associated with the event. The multimedia file may remain latent until a user provides an indication to activate the file. For example, the system may play an audio or video file associated with an event when a user clicks on or otherwise selects the event. The system may play the multimedia file using an embedded media player, or may launch a separate application to play the multimedia file. The arrows connecting events to a timescale correspond to the point in time at which the event occurred. For example, Event1 occurred sometime between Jan. 1, 2005 and Jul. 1, 2005 while Event2 occurred sometime after Jan. 1, 2006 but before Jul. 1, 2007. In some embodiments, an event may be associated with a range of time and be connected to a timescale using a graphical element that spans a range on the timescale.

The system also allows one or more annotations 215 to be associated with the timeline. Timeline 200 contains two annotations, Annotation) and Annotation2. Annotation) is represented as a text box while Annotation2 is represented as an image (“IMAGE2”). Annotations differ from events in that they are not associated with a point in time on the timescale. Instead, the system allows a user to place annotations anywhere on the timeline where they might make a visual impression. In a similar fashion to events, the system may allow annotations to be displayed using a variety of treatments and may allow a user to associate a multimedia file with the annotation. When the user clicks on or otherwise selects an annotation, the system launches a player that plays the multimedia file.

The system allows timelines to be linked to, or nested within, other timelines. In the timeline depicted in FIG. 2, three nested timeline identifiers 220 (“NestedTimeline1,” “NestedTimeline2,” and “NestedTimeline3”) indicate that three timelines are associated with timescale 205. Each nested timeline identifier is represented as a rectangle that is associated with either a range (i.e., spanning from a start time to an end time) or a point on the timescale. For example, NestedTimeline1 has a start time of Jul. 1, 2005 and an end time of Jan. 1, 2006, indicating that all of the events represented in NestedTimeline1 occurred on or after Jul. 1, 2005 and on or before Jan. 1, 2006. In contrast, NestedTimeline3 is associated with point on the timescale corresponding to a date that occurs prior to Jan. 1, 2008. As will be discussed in additional detail herein, NestedTimeline3 has a timescale that is significantly different enough from the timescale of timeline 200 so as to cause the nested timeline to be associated with a point rather than a range. Each nested timeline indicator 220 on the timeline may have a multimedia file that is associated with the indicated nested timeline. In some embodiments, the system may provide an icon or other indication on the nested timeline indicator indicating that there is a multimedia file associated with the indicated nested timeline. The multimedia file may remain latent until a user provides an indication to activate the file.

A user can view the timeline associated with a nested timeline identifier by, for example, clicking on or otherwise selecting the nested timeline identifier. In some embodiments, the system may display a nested timeline in the same window as its parent timeline. In some embodiments, the system may display a nested timeline in a new window. Various animations or other techniques may be used to clearly show the relationship between a parent timeline and a nested timeline. For example, when a user selects a nested timeline identifier, the portion of the timescale that corresponds to the nested timeline identifier may be shown as expanding until it fills the user interface window. At the same time that the nested timeline is expanding, the other non-identified portions of the timescale may be shrinking until they are a minimal size, until the non-identified portions are represented by an icon or other graphic, or until they disappear. By expanding the nested timeline while at the same time shrinking the parent timeline, a user is able to more readily appreciate the relationship between the timelines. A user may be able to return to the parent timeline by selecting the minimized portions of the parent timeline, at which time the parent timeline would expand in size and the nested timeline would shrink in size. Those skilled in the art will appreciate that other animations may also by utilized by the system, such as expanding or overlapping windows.

Timeline 200 also includes a timeline break 225 represented as two hash marks between Jan. 1, 2006 and Jul. 1, 2007. A timeline break allows a user to shorten the length of the timeline by removing a period of time from the timeline. For example, if no significant events occurred during a relatively long period of time, a user may choose to replace that period of time with a timeline break to reduce the amount of unused space in the timeline.

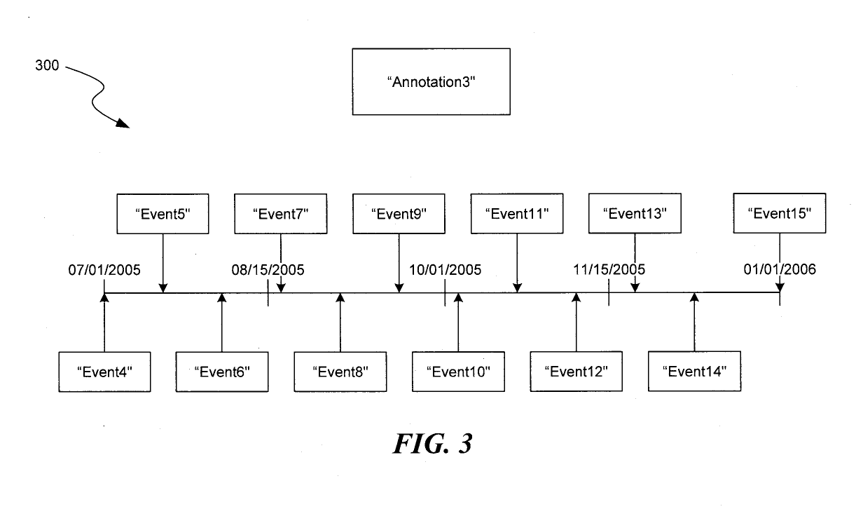

FIG. 3 is a representative display page of a nested timeline 300, such as might be displayed when a user clicks on or otherwise selects a nested timeline identifier. In this example, the nested timeline corresponds to NestedTimeline1 from FIG. 2. The start date and the end date of the nested timeline correspond to the dates at which NestedTimeline1 is connected to the timescale in FIG. 2. The timeline 300 depicted in FIG. 3 has a different timescale than the timeline 200 in FIG. 2. The different timescale allows events that occur closely in time to be displayed in a clearer fashion on timeline 300 than they might otherwise be displayed on the timeline 200. That is, if the system attempted to depict all of the events associated with timeline 300 on timeline 200, the events would all be compressed into a small portion of the timeline, thereby impacting the clarity of the timeline. In the depicted example, twelve events and one annotation are included in the nested timeline. Nested timelines thereby allow a system user to “zoom in” on a portion of a timeline to see the events associated with that portion of time in greater detail. A user may return to the parent timeline to which the nested timeline is linked by entering a system command or by selecting a representation of the parent timeline that the system may generate on the nested timeline.

Although not shown in FIG. 3, a nested timeline may itself include one or more additional nested timelines. The use of nested timelines allows a user to represent as many events as the user would like without creating a cluttered timeline, a timeline that is too long to represent on a single page, or a timeline that has elements that are so small as to be detrimental to understanding the series of events represented in the timeline. The technology described herein does not limit the depth to which a user may nest timelines.

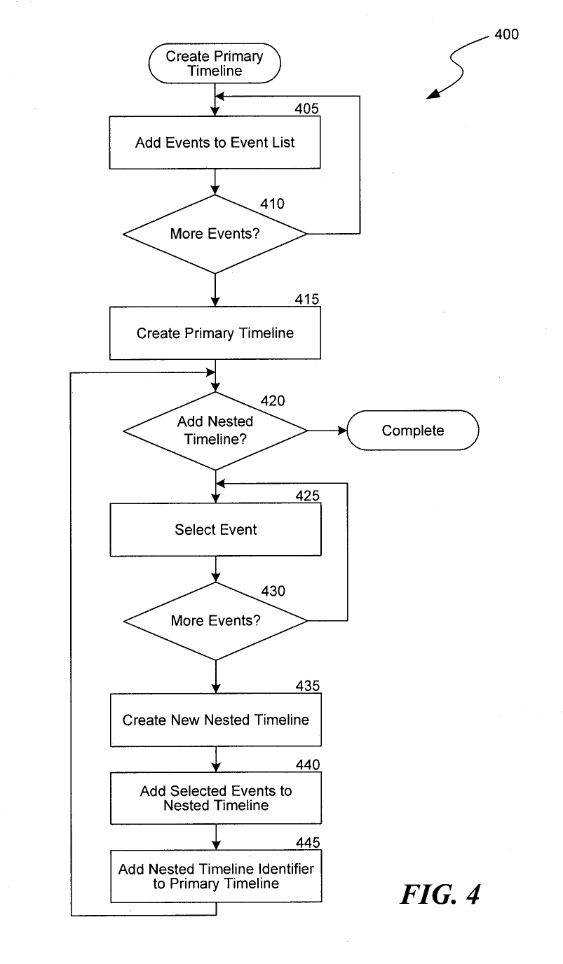

FIG. 4 is a flow diagram illustrating the process 400 by which a timeline is created by the system. Initially, a user may create a list of events or upload a previously created list of events. Each event entered by a user may include one or more of the following attributes:
a time or a range of times associated with the event;
a multimedia file associated with the event (e.g., an image captured from a video file, a supporting document or documents related to the event);
an explicit assignment of the event to a particular timeline;
a party associated with the event (e.g., a plaintiff or defendant);
a format in which to display the event in a timeline (e.g., if an image is associated with an event, a user may select to represent the event as an image connected to the timeline or may display the image in conjunction with a text box that includes text describing the image); and
other text or data associated with the event.

In some embodiments, event information is stored in a table consisting of rows and columns, each row corresponding to a separate event and each column corresponding to a separate attribute of the event. Those skilled in the art will recognize that event information may be stored in any number of configurations and contain any number of attributes.

At block 405, an individual event is added to the event list for the primary timeline. Once an event has been added to the event list, the system at block 410 repeats the procedure to add additional events until no additional events remain to be added to the event list. At block 415, after all desired events have been added to the event list, the system constructs and displays the primary timeline. For example, the system generates a timescale with a start date corresponding to the earliest selected event and an end date corresponding to the latest selected event, and populates the timescale with events. After the timeline is created, a user may modify the timeline in any number of ways. For example, a user may change the style of the timeline (e.g., colors, font, the size of timescale), add annotations, move events to different locations on the timeline, or remove, add, or otherwise modify events.

In some embodiments, a user may create a nested timeline by selecting events on a primary timeline and providing an indication to create a nested timeline. For example, at block 425, a user selects an event to be added to the nested timeline. Once the event has been selected for addition to the nested timeline, the system at block 430 repeats the procedure to add additional event selections until no additional event selections remain to be added to the list for the nested timeline. At block 430, after all selected events have been added to list for the nested timeline, the system creates the nested timeline at block 435 and adds the selected events to the nested timeline at block 440. The selected events are then removed from the primary timeline, and the system generates a link between the nested timeline and a nested timeline identifier that is placed on the primary timeline at a block 445. The process for adding a nested timeline to a primary timeline may be repeated by returning to block 420 until all desired nested timelines have been added. Furthermore, a nested timeline may be added to a nested timeline in a similar manner (i.e., selecting events and providing an indication to create a nested timeline that include the selected events). In some embodiments, events occurring between a start date and an end date of a nested timeline are automatically placed in the nested timeline when the event or the nested timeline is created. In some embodiments, the system automatically creates a nested timeline when more than a threshold number of events occur during a pre-determined length of time. For example, a user may specify that if more than nine events occur during a certain period on a timeline (e.g., one hour, one day), the events should be replaced by a nested timeline identifier and moved to the nested timeline.

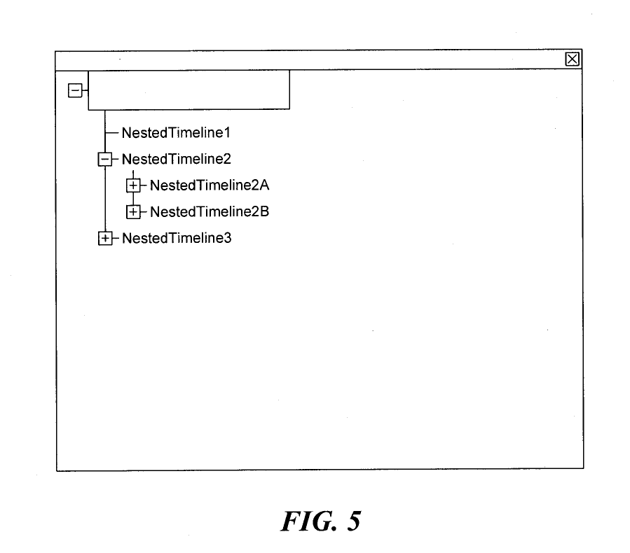

FIG. 5 is a representative display page showing a timeline hierarchy menu generated by the system. The hierarchy menu provides a view of the relationship between the primary timeline and the associated nested timelines. For example, the hierarchy menu displayed in FIG. 5 shows that a primary timeline that contains three nested timelines, NestedTimeline1, NestedTimeline2, and NestedTimeline3 and that NestedTimeline2, contains two further nested timelines, NestedTimeline2A and NestedTimeline2B. The items displayed in the hierarchy menu can be collapsed or expanded to hide or show menu items. For example, a user may click the “+” next to NestedTimeline3 to cause the hierarchy menu to display additional nested timelines that may be associated with NestedTimeline3. In some embodiments, the hierarchy menu may be used as a navigation tool for selecting a timeline to display. For example, if a user were to click on menu item “NestedTimeline3,” the system may display NestedTimeline3.

From the foregoing, it will be appreciated that specific embodiments of the invention have been described herein for purposes of illustration, but that various modifications may be made without deviating from the scope of the invention. Those skilled in the art will appreciate that the depicted flow charts may be altered in a variety of ways. For example, the order of the steps may be rearranged, steps may be performed in parallel, steps may be omitted, or other steps may be included. Accordingly, the invention is not limited except as by the appended claims.

1. A computer system, comprising:
a memory for storing a sequence of program instructions;
processor electronics configured to execute the instructions in order to display a timeline of events by:
receiving event data for one or more events occurring between a start time and an end time;
producing a display that illustrates a first timeline representing the time between the start time and the end time and that illustrates a time at which one or more of the events occur on the first timeline, wherein the display further includes an icon representing a nested timeline that spans a portion of the time between the start time and the end time of the first timeline; and
producing a display that illustrates the nested timeline and a time at which one or more events occur on the nested timeline.

2. The computer system of claim 1, wherein the instructions are executable by the processor electronics to produce the display that illustrates the nested timeline in a timescale that is different than a timescale of the first timeline.

3. A non-transitory computer readable media containing program instructions that are executable by processor electronics to produce a display by:
receiving event data for one or more events occurring between a start time and an end time;
producing a display that illustrates a first timeline representing the time between the start time and the end time and that illustrates a time at which one or more of the events occur on the first timeline, wherein the display further includes an icon representing a nested timeline that spans a portion of the time between the start time and the end time of the first timeline; and
producing a display that illustrates the nested timeline and a time at which one or more events occur on the nested timeline.

4. A method performed by a computing system for creating a timeline presentation that includes at least one nested timeline associated with a primary timeline, comprising:
receiving, via a computing system, event data for a plurality of events, wherein the event data includes at least a start time for each event in the plurality of events;
constructing, by the computing system, a primary timeline, wherein the primary timeline is associated with a first timescale, and wherein at least one of the plurality of events is placed on the primary timeline;
constructing, by the computing system, a nested timeline, wherein the nested timeline is associated with a second timescale, and wherein at least one of the plurality of events is placed on the nested timeline;
associating, by the computing system, the nested timeline with the primary timeline, wherein a visual indication representing the nested timeline is placed on the primary timeline;
presenting, on an output display, the primary timeline;
receiving, via the computing system, a selection of the visual indication of the nested timeline; and
presenting, on the output display, the nested timeline in response to receiving the selection of the visual indication.

5. The computer-implemented method of claim 4, wherein constructing the nested timeline includes selecting one or more events from the primary timeline and receiving an indication to move the one or more events from the primary timeline to the nested timeline.

6. The computer-implemented method of claim 4, wherein constructing the nested timeline includes automatically moving one or more events from the primary timeline to the nested timeline when a predetermined number of events occurs within a predetermined time period.

7. The computer-implemented method of claim 4, wherein the second timescale is equal to the first timescale.

8. The computer-implemented method of claim 4, wherein presenting the nested timeline further includes animating the presentation such that the display size of the primary timeline is reduced and the display size of the nested timeline is increased.

9. The computer-implemented method of claim 4, wherein a visual indication representing the primary timeline is placed on the nested timeline, and further wherein a selection of the visual indication of the primary timeline causes the primary timeline to be presented on the output device.

10. The computer-implemented method of claim 9, wherein presenting the primary timeline further includes animating the presentation such that the display size of the first nested timeline is reduced and the display size of the primary timeline is increased.

11. The computer-implemented method of claim 4, further comprising constructing one or more additional nested timelines, wherein the one or more additional nested timelines are associated with the primary timeline, and wherein at least one of the plurality of events is placed on each of the one or more additional nested timelines.

12. The computer-implemented method of claim 4, further comprising constructing one or more additional nested timelines, wherein the one or more additional nested timelines are associated with the nested timeline, and wherein at least one of the plurality of events is placed on each of the one or more additional nested timelines.

13. A computing system configured to create a timeline presentation that includes at least one nested timeline associated with a primary timeline, the computing system comprising:
a memory storing computer-executable instructions of:
an editor configured to receive event data for a plurality of events, each of the plurality of events having an associated time, the editor constructing:
a primary timeline that has a first timescale and contains an indication of at least one of the plurality of events at its associated time; and
a nested timeline that has a second timescale and contains an indication of at least one of the plurality of events at its associated time, wherein the nested timeline is associated with the primary timeline and is represented on the primary timeline by a visual indication; and
a presentation engine configured to present the primary timeline on an output display, and, upon receipt of a selection of the visual indication of the nested timeline, present the nested timeline on the output display; and
a processor for executing the computer-executable instructions stored in the memory.

14. The computing system of claim 13, wherein the editor constructs the nested timeline by receiving a selection of one or more events from the primary timeline and receiving an indication to move the one or more events from the primary timeline to the nested timeline.

15. The computing system of claim 13, wherein the editor automatically constructs the nested timeline by moving one or more events from the primary timeline to the nested timeline when a predetermined number of events occurs within a predetermined time period.

16. The computing system of claim 13, wherein the second timescale is equal to the first timescale.

17. The computing system of claim 13, wherein the presentation engine is further configured to animate the presentation of the primary timeline such that the display size of the primary timeline is reduced and the display size of the nested timeline is increased.

18. The computing system of claim 13, wherein the editor is further configured to place a visual indication representing the primary timeline on the nested timeline, and wherein the presentation engine is configured to cause the primary timeline to be presented on the output device upon receipt of a selection of the visual indication of the primary timeline.

19. The computing system of claim 18, wherein the presentation engine is configured to animate the presentation such that the display size of the first nested timeline is reduced and the display size of the primary timeline is increased.

20. The computing system of claim 13, wherein the editor is further configured to construct additional nested timelines, wherein the additional nested timelines are associated with the primary timeline, and wherein at least one of the plurality of events is placed on each of the additional nested timelines.

21. The computing system of claim 13, wherein the editor is further configured to construct additional nested timelines, wherein the additional nested timelines are associated with the nested timeline, and wherein at least one of the plurality of events is placed on each of the additional nested timelines.
